(19) United States
(12) Patent Application Publication
(10) Pub. No.: US 2016/0290283 A1
(43) Pub. Date: Oct. 6, 2016

(54) FLUID-POWERED THRUST REVERSER ACTUATION SYSTEM WITH ELECTROMECHANICAL SPEED CONTROL

(71) Applicant: HONEYWELL INTERNATIONAL INC., Morristown, NJ (US)

(72) Inventors: Ron Vaughan, Gilbert, AZ (US); Kevin K. Chakkera, Chandler, AZ (US); James Wawrzynek, Phoenix, AZ (US); Leroy Allen Fizer, Huntington, CA (US)

(73) Assignee: HONEYWELL INTERNATIONAL INC., Morristown, NJ (US)

(21) Appl. No.: 14/672,938

(22) Filed: Mar. 30, 2015

(51) Int. Cl. F02K 1/76

(52) U.S. Cl. CPC F02K 1/763

(57) ABSTRACT

A fluid-powered thrust reverser actuation system includes electromechanical speed control to implement multiple mid-stroke speeds. The system may also be configured to implement two different operational modes—a normal operational mode and a rejected take-off operational mode.

### TECHNICAL FIELD

The present invention generally relates to thrust reverser actuation systems, and more particularly relates to a fluid-powered thrust reverser actuation system with electromechanical speed control.

### BACKGROUND

When a jet-powered aircraft lands, the landing gear brakes and aerodynamic drag (e.g., flaps, spoilers, etc.) of the aircraft may not, in certain situations, be sufficient to slow the aircraft down in the required amount of runway distance. Thus, jet engines on most aircraft include thrust reversers to enhance the braking of the aircraft. When deployed, a thrust reverser redirects the rearward thrust of the jet engine to a generally or partially forward direction to decelerate the aircraft. Because at least some of the jet thrust is directed forward, the jet thrust also slows down the aircraft upon landing.

Various thrust reverser system designs are commonly known, and the particular design utilized depends, at least in part, on the engine manufacturer, the engine configuration, and the propulsion technology being used. Regardless of the specific thrust reverse system used, each includes thrust reverser movable components that are selectively deployed to enhance the braking of the aircraft, and thereby shorten the stopping distance during landing and reduce the burden on landing gear brakes. During the landing process, the thrust reverser movable components may be deployed to assist in slowing the aircraft. Thereafter, when the thrust reversers are no longer needed, the thrust reverser movable components are returned to their original, or stowed, position.

The thrust reverser movable components are moved between the stowed and deployed positions by actuators. Power to drive the actuators may come from one or more drive units, which may be electric, pneumatic, or hydraulic drive, depending on the system design. A drive train that includes one or more drive shafts, such as flexible rotating shafts, may interconnect the actuators and the one or more drive mechanisms to transmit the drive mechanism drive force to the thrust reverser movable components and/or to synchronize the reverser components.

Fluid-powered thrust reverser systems, both hydraulic and pneumatic, have been historically used in aircraft because of the robustness of the components and the abundant availability of hydraulic and pneumatic fluid onboard most aircraft. Recently, however, current propulsion engine manufacturers are looking at improving engine efficiency and thrust reverser performance by reducing the drag profile of the thrust reverser mechanism. One way to accomplish this is to implement relatively high movement speeds during the early part of thrust reverser deployment, and relatively slower speeds later in the stroke when aerodynamic loading becomes more prevalent. Unfortunately, presently known fluid-powered thrust reverser systems are not configured to readily implement such multi-speed control.

Hence, there is a need for a fluid-powered aircraft thrust reverser actuation system that can readily implement multi-speed control. The present invention addresses at least this need.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, an aircraft thrust reverser actuation system includes a plurality of actuator assemblies, a fluid-powered motor, a position sensor, a motor speed sensor, a control valve, and a control. Each actuator assembly is coupled to receive a drive torque and is configured, upon receipt of the drive torque, to move to a position. The fluid-powered motor is coupled to each of the actuator assemblies and is adapted to selectively receive fluid at a fluid flow rate. The fluid-powered motor is configured, upon receipt of the fluid, to rotate and supply the drive torque to each of the actuator assemblies. The position sensor is coupled to at least one of the actuator assemblies, and is configured to sense actuator position and supply a position feedback signal representative thereof. The motor speed sensor is configured to sense rotational speed of the fluid-powered motor and supply a speed feedback signal representative thereof. The control valve is in fluid communication with the fluid-powered motor and is coupled to receive valve control signals. The control valve is configured, in response to the valve control signals, to move to a commanded valve position, to thereby control the direction and flow of fluid to the fluid-powered motor, and thereby control movement direction and movement speed of the actuator assemblies. The control is coupled to receive thrust reverser commands, the position feedback signal, and the speed feedback signal. The control is configured, in response to the thrust reverser commands, the position feedback signal, and the speed feedback signal, to supply valve control signals to the control valve that selectively cause the actuator assemblies to move at a plurality of movement speeds.

In another embodiment, an aircraft thrust reverser actuation system includes a plurality of actuator assemblies, a rotary pneumatic motor, a position sensor, a motor speed sensor, a control valve, and a control. Each actuator assembly is coupled to receive a drive torque and is configured, upon receipt of the drive torque, to move to between a fully stowed and a fully deployed position. The rotary pneumatic motor is coupled to each of the actuator assemblies and is adapted to selectively receive pressurized air at a flow rate. The rotary pneumatic motor is configured, upon receipt of the pressurized air, to rotate and supply the drive torque to each of the actuator assemblies. The position sensor is coupled to at least one of the actuator assemblies, and is configured to sense actuator position and supply a position feedback signal representative thereof. The motor speed sensor is configured to sense rotational speed of the rotary pneumatic motor and supply a speed feedback signal representative thereof. The control valve is in fluid communication with the rotary pneumatic motor and is coupled to receive valve control signals. The control valve is configured, in response to the valve control signals, to move to a commanded valve position, to thereby control the direction and flow of pressurized air to the rotary pneumatic motor, and thereby control movement direction and movement speed of the actuator assemblies. The control is coupled to receive thrust reverser commands, the position feedback signal, and the speed feedback signal. The control is configured, in response to the thrust reverser commands, the position feedback signal, and the speed feedback signal, to supply the valve control signals to the control valve that cause the actuator assemblies to move at a plurality of movement speeds when translating between the fully stowed position and the fully deployed position.

In yet another embodiment, an aircraft thrust reverser actuation system includes a plurality of actuator assemblies, a rotary pneumatic motor, a position sensor, a motor speed sensor, a motor-actuated directional control valve, and a control. Each actuator assembly is coupled to receive a drive torque and is configured, upon receipt of the drive torque, to move to between a fully stowed and a fully deployed position. The rotary pneumatic motor is coupled to each of the actuator assemblies and is adapted to selectively receive pressurized air at a flow rate. The rotary pneumatic motor is configured, upon receipt of the pressurized air, to rotate and supply the drive torque to each of the actuator assemblies. The position sensor is coupled to at least one of the actuator assemblies, and is configured to sense actuator position and supply a position feedback signal representative thereof. The motor speed sensor is configured to sense rotational speed of the rotary pneumatic motor and supply a speed feedback signal representative thereof. The motor-actuated directional control valve is in fluid communication with the rotary pneumatic motor and is coupled to receive valve control signals. The motor-actuated directional control valve is configured, in response to the valve control signals, to move to a commanded valve position, to thereby control the direction and flow of pressurized air to the rotary pneumatic motor, and thereby control movement direction and movement speed of the actuator assemblies. The control is coupled to receive thrust reverser commands, the position feedback signal, and the speed feedback signal. The control is configured, in response to the thrust reverser commands, the position feedback signal, and the speed feedback signal, to supply the valve control signals to the motor-actuated directional control valve that cause the actuator assemblies to (i) move at a first movement speed when the actuator assemblies are translating toward the fully deployed position and are between the fully stowed position a first actuator position, and (ii) then move at a second movement speed when the actuator assemblies are translating toward the fully deployed position and are between the first actuator position and the fully deployed position.

Furthermore, other desirable features and characteristics of the thrust reverser actuation system will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a functional block diagram of an exemplary fluid-powered thrust reverser actuation system for a single jet engine; and

FIG. 2 is a graph depicting various actuator assembly movement speeds that are implemented in the system of FIG. 1.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

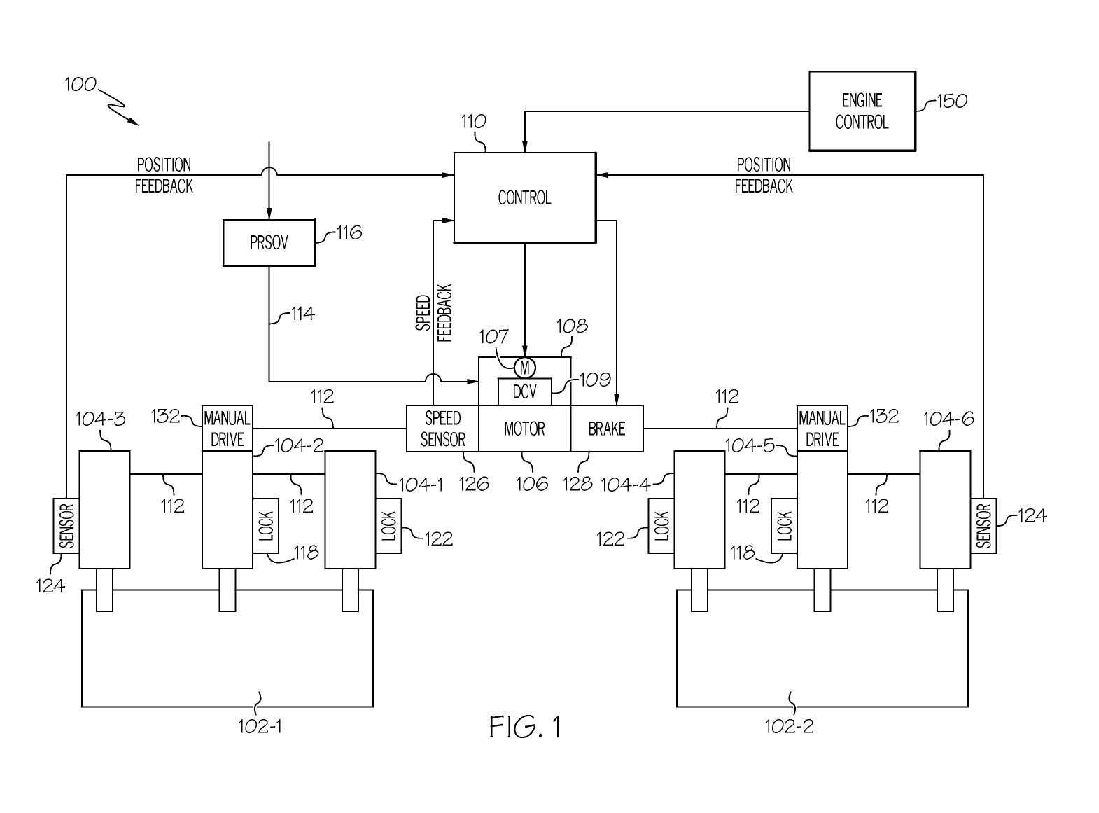

Referring now to FIG. 1, a functional block diagram of an exemplary fluid-powered thrust reverser actuation system 100 for a single jet engine is depicted. The depicted system 100 includes a plurality of thrust reverser movable components 102, a plurality of actuator assemblies 104, one or more fluid-powered motors 106 (only one depicted), one or more control valves 108 (only one depicted), and a control 110.

The thrust reverser movable components 102 are movable between a stowed position and a deployed position. The thrust reverser movable components 102 may be implemented as any one of numerous types of components, depending upon the particular type of thrust reverser actuation system being implemented. For example, the thrust reverser movable components 102 may be implemented as transcowls if the thrust reverser actuation system 100 is a cascade-type thrust reverser system or as a plurality of doors if the thrust reverser actuation system 100 is a target-type thrust reverser system or pivot door thrust reverser system. Moreover, while two thrust reverser movable components 102 (102-1, 102-2) are depicted, it will be appreciated that the system 100 may be implemented with more than this number.

The actuator assemblies 104 are individually coupled to the thrust reverser movable components 102. In the depicted embodiment, the system 100 includes six actuator assemblies 104-1, 104-2, 104-3, 104-4, 104-5, 104-6, with three of the actuator assemblies 104-1, 104-2, 104-3 being coupled to one of the thrust reverser movable components 102-1, and the other three actuator assemblies 104-4, 104-5, 104-6 being coupled to the other thrust reverser movable component 102-2. It is noted that the actuator assemblies 104 may be implemented using any one of numerous types of actuator assemblies now known or developed in the future. Some non-limiting examples of suitable actuator assemblies include ball screw actuators, roller screw actuators, and piston-type actuators, just to name a few. It is additionally noted that the number, arrangement, and configuration (e.g., with or without locks, position sensors, etc.) of the actuator assemblies 104 is not limited to the arrangement depicted in FIG. 1, but could include other numbers, arrangements, and configurations of actuator assemblies 104.

The fluid-powered motor 106 is coupled to each of the thrust reverser movable components 102. More specifically, the fluid-powered motor 106 is separately coupled, via a pair of drive shafts 112, to one of the actuator assemblies 104 (e.g., 104-2, 104-5) associated with each thrust reverser movable component 102. Moreover, the remaining actuator assemblies 104 (104-1, 104-3 and 104-4, 104-6) associated with each thrust reverser movable component 102 are interconnected with, and driven by the motor-driven actuators 104-2, 104-5 via drive shafts 112. The drive shafts 112 are preferably implemented as flexible shafts. Using flexible shafts in this configuration preferably ensures that the actuator assemblies 104 and thrust reverser movable components 102 move in a substantially synchronized manner.

The fluid-powered motor 106 is also coupled to selectively receive fluid at a fluid flow rate and is configured, upon receipt of the fluid, to rotate and supply the drive torque to each of the actuator assemblies 104. In the depicted embodiment, fluid-powered motor 106 is a pneumatic motor, and the fluid is pressurized air. The pressurized air is supplied to the motor 106 from a non-illustrated pressurized air source via a pneumatic supply line 114 and pressure-regulating-and-shut-off-valve (PRSOV) 116. The fluid-powered motor 106 is configured, upon receipt of fluid, to supply a drive force, via the drive shafts 112, and actuator assemblies 104, to move the thrust reverser movable components 102 in either a deploy direction or a stow direction. The rotational direction and speed of the fluid-powered motor 106, and hence the movement direction and speed of the thrust reverser movable components 102, depends upon the direction and the pressure (or flow) of the fluid supplied to the fluid-powered motor 106. The direction and pressure (or flow) of the fluid supplied to the fluid-powered motor 106 is controlled via the control valve 108.

The control valve 108 is in fluid communication with the fluid-powered motor 106 and is coupled to receive valve control signals from the control 110. The control valve 108 is configured, in response to the valve control signals, to move to a commanded valve position. It will be appreciated that the control valve 108 may be variously implemented, but in the depicted embodiment it is implemented as a motor-actuated directional control valve (DCV) 108, and thus includes a motor 107 and a directional control valve 109. As such, the control valve 108 functions to control the direction and flow of fluid to the fluid-powered motor 106, to thereby control the movement direction and movement speed of the actuator assemblies 104, and hence the thrust reverser movable components 102.

Before describing the control 110 and its associated functionality, it is seen in FIG. 1 that the depicted system 100 additionally includes various locks and sensors. In particular, the system 100 includes two latch-type locks 118, two bar-type locks 122, two position sensors 124, and a motor speed sensor 126. One actuator assembly 104 (e.g., 104-2 and 104-5) per thrust reverser movable component 102 includes a latch-type lock 118, and one actuator assembly 104 (e.g., 104-1 and 104-4) per thrust reverser movable component 102 includes a bar-type lock 122. Moreover, the two actuator assemblies 104 that include the latch-type locks 118 each additionally include a manual drive 132.

The latch-type locks 118 and the bar-type locks 122 are each motor-actuated locks that are mechanically integrated with the associated actuator assemblies 104. The latch-type locks 118 each include a lock motor (e.g., direct solenoid or solenoid controlled, fluid actuated) and a spring-loaded latch that is configured to retain the associated actuator assembly 104-2, 104-5 in the stowed position. The bar-type locks 122 each include a lock motor (e.g., direct solenoid or solenoid controlled, fluid actuated) and a spring-loaded bar that is configured to block the actuator assembly drive shaft to retain the associated actuator assembly 104-1, 104-4 in the stowed position. The latch-type locks 118 and bar-type locks 122 are both configured to retain the associated actuator assemblies until the associated lock motor (e.g., direct solenoid or solenoid controlled, fluid actuated) is energized, and an overstow command is provided to unload the lock. Though not separately illustrated, the latch-type locks 118 and the bar-type locks 122 each include lock position sensors to sense the positions of the associated locks 118, 122. The lock position sensors are further configured to supply lock position signals to the control 110. The lock position sensors may be variously configured and implemented to provide this functionality, but in the depicted embodiment each is implemented using a proximity sensor.

The actuator position sensors 124 are configured to sense actuator assembly position and supply a position feedback signal representative thereof to the control 110. The actuator position sensors 124 may be variously configured and implemented. For example, these sensors 124 may be implemented using a transformer position sensor, such as a linear variable differential transformer (LVDT) or a rotary variable differential transformer (RVDT). In the depicted embodiment, however, the actuator position sensors 124 are implemented using magneto-resistive (MR) position sensors. Regardless of the specific implementation, the position sensors 124 are each coupled to a different one of the actuator assemblies 104 (e.g., 104-3, 104-6), and each supplies a position feedback signal representative thereof to the control 110.

The motor speed sensor 126 is configured to sense the rotational speed of the fluid-powered motor 106, and supply a speed feedback signal representative thereof to the control. The motor speed sensor 126 may be variously configured and implemented, but in the depicted embodiment it is a monopole sensor that is coupled to the fluid-powered motor 106.

The brake 128 is coupled to the fluid-powered motor 106, and is also coupled to receive brake commands. The brake 128, which may be configured as an electric brake, a pneumatic brake, or a hydraulic brake, is configured, in response to the brake commands, to selectively move to an engaged position to thereby prevent rotation of the fluid-powered motor 106 or, as will be described further below, to slow rotation of the fluid-powered motor 106. In the depicted embodiment, the brake commands are selectively supplied to the brake 128 from the control 110. In other embodiments, however, the brake commands could be supplied from another source.

The control 110 is in operable communication with, and receives thrust reverser commands from, for example, an engine control 150. The control 110 is also coupled to receive the position feedback signals from the actuator position sensors 124, and the speed feedback signal from the motor speed sensor 126. The control 110 is configured, in response to the thrust reverser commands, the position feedback signals, and the speed feedback signal, to supply valve control signals to the control valve 108, and to also preferably control the locks 118, 122, to thereby controllably move the thrust reverser movable components 102 between the stowed and deployed positions. The control 110 is preferably configured to implement speed control logic. As such, the valve control signals the control 110 generates and supplies to the control valve 108 selectively cause the actuator assemblies 104 (and thus the thrust reverser movable components 102) to move at a plurality of movement speeds. Preferably, the plurality of movement speeds occurs during mid-stroke operation of the actuator assemblies 104, at least when the actuator assemblies 104 are being commanded to move toward the fully deployed position. It will be appreciated, however, that the movement speeds may also vary when the actuator assemblies 104 are being commanded to move toward the fully stowed position.

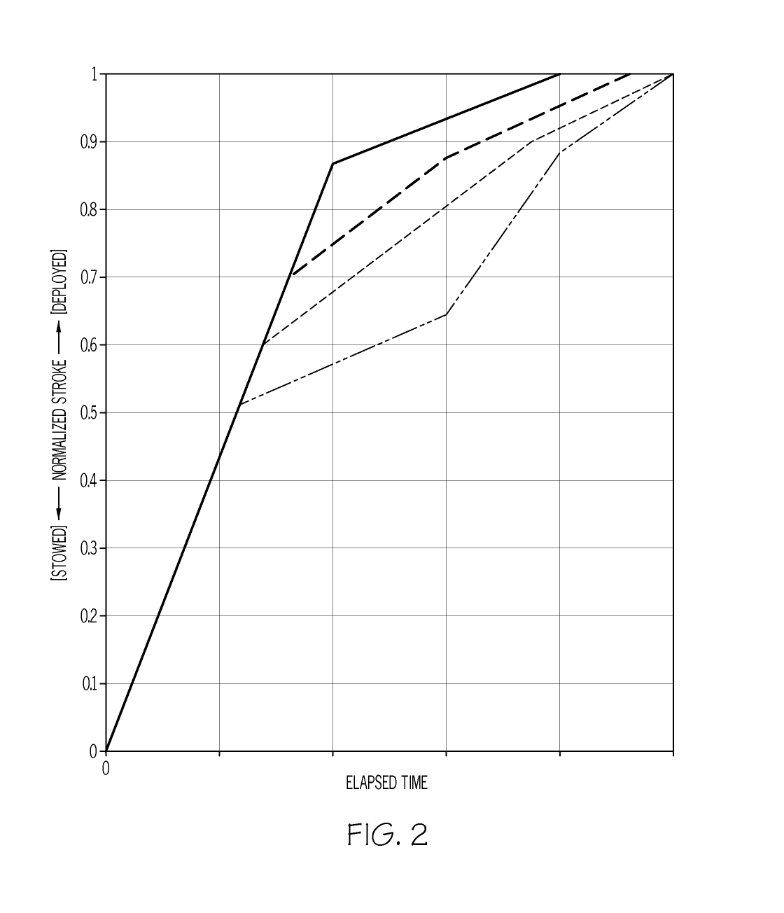

The number of movement speeds that the control 110 will command the actuator assemblies 104 (and thus the thrust reverser movable components 102) to move at may vary depending, for example, on the particular speed schedule being implemented by the speed control logic. For example, in one embodiment, which is shown using solid lines in FIG. 2, the control 110 is configured to supply valve control signals to the control valve 106 that cause the actuator assemblies 104 to move at a first movement speed when the actuator assemblies 104 are translating toward the fully deployed position and are between the fully stowed position a first actuator position, and then at a second movement speed when the actuator assemblies are translating toward the fully deployed position and are between the first actuator position and the fully deployed position.

Before proceeding further, it is noted that, at least in the depicted embodiment, the second movement speed is less than the first movement speed. This is merely exemplary of one preferred speed schedule. Other speed schedules could have the second movement speed greater than the first movement speed. It is additionally noted that the actuator position at which the second movement speed is commanded is less than a typical near end-of-stroke (or “snubbing”) position. For example, the first actuator position is typically less than about 90% of the fully deployed position. In the depicted embodiment, for example, it is about 87% of the fully deployed position.

As previously noted, the control 110 may implement a speed schedule that commands more than two actuator movement speeds. In such embodiments, the control 110 is configured to generate and supply valve control signals to the control valve 108 that cause the actuator assemblies 104 (and thus the thrust reverser movable components 102) to move at one or more additional movement speeds when the actuator assemblies 104 are translating between the fully deployed and fully stowed positions. As FIG. 2 depicts using the various dashed lines, the one or more additional movement speeds are each different than the first and second movement speeds, and the one or more other actuator positions are each different than the first actuator position.

It was noted above that the brake 128 may be used to slow rotation of the fluid-powered motor 106. For example, the brake 128 may be used for dynamic braking as part of the normal speed control. In some embodiments, if an overspeed condition exists the control 110 may supply brake commands to the brake 128 to slow the rotation of the fluid-powered motor 106, and thus the movement speed of the actuator assemblies 104. It will be additionally appreciated that the brake 128 may be used for either normal deploy operations and/or for a rejected take-off operation. In this regard, it is noted that the control 110 may also be configured to implement two different operational modes—a normal operational mode and a rejected take-off operational mode.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An aircraft thrust reverser actuation system, comprising:
a plurality of actuator assemblies, each actuator assembly coupled to receive a drive torque and configured, upon receipt of the drive torque, to move to a position;
a fluid-powered motor coupled to each of the actuator assemblies and adapted to selectively receive fluid at a fluid flow rate, the fluid-powered motor configured, upon receipt of the fluid, to rotate and supply the drive torque to each of the actuator assemblies;
a position sensor coupled to at least one of the actuator assemblies, the position sensor configured to sense actuator position and supply a position feedback signal representative thereof;
a motor speed sensor configured to sense rotational speed of the fluid-powered motor and supply a speed feedback signal representative thereof;
a control valve in fluid communication with the fluid-powered motor and coupled to receive valve control signals, the control valve configured, in response to the valve control signals, to move to a commanded valve position, to thereby control the direction and flow of fluid to the fluid-powered motor, and thereby control movement direction and movement speed of the actuator assemblies; and
a control coupled to receive thrust reverser commands, the position feedback signal, and the speed feedback signal, the control configured, in response to the thrust reverser commands, the position feedback signal, and the speed feedback signal, to supply valve control signals to the control valve that selectively cause the actuator assemblies to move at a plurality of movement speeds.

2. The system of claim 1, wherein:
the actuator assemblies are each configured to move between a fully stowed position and a fully deployed position; and
the control is configured to supply valve control signals to the control valve that cause the actuator assemblies to move at a first movement speed when the actuator assemblies are translating toward the fully deployed position and are between the fully stowed position a first actuator position, and then at a second movement speed when the actuator assemblies are translating toward the fully deployed position and are between the first actuator position and the fully deployed position.

3. The system of claim 2, wherein:
the second movement speed is less than the first movement speed; and
the first actuator position is less than 90% of the fully deployed position.

4. The system of claim 2, wherein:
the control is further configured to supply valve control signals to the control valve that cause the actuator assemblies to move at one or more additional movement speeds when the actuator assemblies are translating toward the fully deployed position and are between the fully stowed position and one or more other actuator positions;
the one or more additional movements are each different than the first and second movement speeds; and
the one or more other actuator positions are each different than the first actuator position.

5. The system of claim 1, further comprising:
a brake coupled to the fluid-powered motor and coupled to receive brake commands, the brake configured, in response to the brake commands, to selectively move to an engaged position to thereby slow rotation of the fluid-powered motor.

6. The system of claim 5, wherein the brake is one of an electric-powered brake or a fluid-powered brake.

7. The system of claim 5, wherein the control is further configured to selectively supply the brake commands to the brake.

8. The system of claim 1, wherein the motor speed sensor comprises a monopole sensor.

9. The system of claim 1, wherein the control valve comprises:
a directional control valve movable to the commanded valve position; and
a motor coupled to the directional control valve and to receive the valve control commands, the motor configured, upon receipt of the valve control commands, to move the directional control valve to the commanded valve position.

10. The system of claim 1, wherein the fluid-powered motor is a rotary pneumatic motor.

11. An aircraft thrust reverser actuation system, comprising:
a plurality of actuator assemblies, each actuator assembly coupled to receive a drive torque and configured, upon receipt of the drive torque, to move to between a fully stowed and a fully deployed position;
a rotary pneumatic motor coupled to each of the actuator assemblies and adapted to selectively receive pressurized air at a flow rate, the rotary pneumatic motor configured, upon receipt of the pressurized air, to rotate and supply the drive torque to each of the actuator assemblies;
a position sensor coupled to at least one of the actuator assemblies, the position sensor configured to sense actuator position and supply a position feedback signal representative thereof;
a motor speed sensor configured to sense rotational speed of the rotary pneumatic motor and supply a speed feedback signal representative thereof;
a control valve in fluid communication with the rotary pneumatic motor and coupled to receive valve control signals, the control valve configured, in response to the valve control signals, to move to a commanded valve position, to thereby control the direction and flow of pressurized air to the rotary pneumatic motor, and thereby control movement direction and movement speed of the actuator assemblies; and
a control coupled to receive thrust reverser commands, the position feedback signal, and the speed feedback signal, the control configured, in response to the thrust reverser commands, the position feedback signal, and the speed feedback signal, to supply the valve control signals to the control valve that cause the actuator assemblies to move at a plurality of movement speeds when translating between the fully stowed position and the fully deployed position.

12. The system of claim 11, further comprising:
a brake coupled to the fluid-powered motor and coupled to receive brake commands, the brake configured, in response to the brake commands, to selectively move to an engaged position to thereby slow rotation of the fluid-powered motor,
wherein the control is further configured to selectively supply the brake commands to the brake.

13. The system of claim 12, wherein the brake is one of an electric-powered brake or a fluid-powered brake.

14. The system of claim 11, wherein the motor speed sensor comprises a monopole sensor.

15. The system of claim 11, wherein the control valve comprises:
a directional control valve movable to the commanded valve position; and
a motor coupled to the directional control valve and to receive the valve control commands, the motor configured, upon receipt of the valve control commands, to move the directional control valve to the commanded valve position.

16. An aircraft thrust reverser actuation system, comprising:
a plurality of actuator assemblies, each actuator assembly coupled to receive a drive torque and configured, upon receipt of the drive torque, to move to between a fully stowed and a fully deployed position;
a rotary pneumatic motor coupled to each of the actuator assemblies and adapted to selectively receive pressurized air at a flow rate, the rotary pneumatic motor configured, upon receipt of the pressurized air, to rotate and supply the drive torque to each of the actuator assemblies;
a position sensor coupled to at least one of the actuator assemblies, the position sensor configured to sense actuator position and supply a position feedback signal representative thereof;
a motor speed sensor configured to sense rotational speed of the rotary pneumatic motor and supply a speed feedback signal representative thereof;
a motor-actuated directional control valve in fluid communication with the rotary pneumatic motor and coupled to receive valve control signals, the motor-actuated directional control valve configured, in response to the valve control signals, to move to a commanded valve position, to thereby control the direction and flow of pressurized air to the rotary pneumatic motor, and thereby control movement direction and movement speed of the actuator assemblies; and
a control coupled to receive thrust reverser commands, the position feedback signal, and the speed feedback signal, the control configured, in response to the thrust reverser commands, the position feedback signal, and the speed feedback signal, to supply the valve control signals to the motor-actuated directional control valve that cause the actuator assemblies to:
(i) move at a first movement speed when the actuator assemblies are translating toward the fully deployed position and are between the fully stowed position a first actuator position, and
(ii) then move at a second movement speed when the actuator assemblies are translating toward the fully deployed position and are between the first actuator position and the fully deployed position.

17. The system of claim 16, wherein:
the second movement speed is less than the first movement speed; and
the first actuator position is less than 90% of the fully deployed position.

18. The system of claim 17, wherein:
the control is further configured to supply valve control signals to the control valve that cause the actuator assemblies to move at one or more additional movement speeds when the actuator assemblies are translating toward the fully deployed position and are between the fully stowed position one or more other actuator positions;
the one or more additional movements are each different than the first and second movement speeds; and
the one or more other actuator positions are each different than the first actuator position.

19. The system of claim 16, further comprising:
a brake coupled to the fluid-powered motor and coupled to receive brake commands, the brake configured, in response to the brake commands, to selectively move to an engaged position to thereby slow rotation of the fluid-powered motor.

20. The system of claim 19, wherein the control is further configured to selectively supply the brake commands to the brake.
